(19) United States
(12) Patent Application Publication
(10) Pub. No.: US 2017/0148107 A1
(43) Pub. Date: May 25, 2017

(54) PRIORITIZING SEARCH TERMS REPRESENTING LOCATIONS

(71) Applicant: Linkedln Corporation, Mountain View, CA (US)

(72) Inventors: Krishnaram Kenthapadi, Sunnyvale, CA (US); Huan Van Hoang, San Jose, CA (US); Zachary Mason Roth, San Francisco, CA (US)

(21) Appl. No.: 14/949,803

(22) Filed: Nov. 23, 2015

(51) Int. Cl. G06Q 50/00; G06F 17/30

(52) U.S. Cl. CPC G06Q 50/01; G06F 17/30864; G06F 17/30899; G06F 17/3053

(57) ABSTRACT

A search engine optimization system is provided with an on-line social network system. The on-line social network system includes or is in communication with a search engine optimization (SEO) system that is configured to prioritize search terms (potential search terms) representing geographic locations, based on their respective predicted value to users. The value of a job-related search term is expressed as a priority score assigned to that search term. The SEO system generates priority scores for different search terms, using a probabilistic model that takes into account a value expressing how likely the search term is to be included in a search query, as well as other signals that are indicative of the relative importance of a location represented by the search term.

### TECHNICAL FIELD

This application relates to the technical fields of software and/or hardware technology and, in one example embodiment, to system and method to prioritize search terms that represent respective organizations in the context of an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member. An on-line social network may store include one or more components for facilitation job-related searched for members, as well as non-members.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to prioritize search terms representing respective geographic locations in an on-line social network system may be implemented;

FIG. 2 is block diagram of a system to prioritize search terms representing respective geographic locations in an on-line social network system, in accordance with one example embodiment;

FIG. 3 is a flow chart illustrating a method to prioritize search terms representing respective geographic locations in an on-line social network system, in accordance with an example embodiment;

FIG. 4 is an example representation of a user interface for navigating a job search directory by location; and

FIG. 5 is a diagrammatic representation of an example machine in the form of a computer system within which a set of instructions, for causing the machine to perform any one or more of the methodologies discussed herein, may be executed.

### DETAILED DESCRIPTION

A method and system to prioritize search terms representing respective geographic locations in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members who are connected in the context of a social network may be termed each other's “connections” and their respective profiles are associated with respective connection links indicative of these two profiles being connected.

The profile information of a social network member may include various information such as, e.g., the name of a member, current and previous geographic location of a member, current and previous employment information of a member, information related to education of a member, information about professional accomplishments of a member, publications, patents, etc. The profile information of a social network member may also include information about the member's professional skills. A particular type of information that may be present in a profile, such as, e.g., company, industry, job position, etc., is referred to as a profile attribute. A profile attribute for a particular member profile may have one or more values. For example, a profile attribute may represent a company and be termed the company attribute. The company attribute in a particular profile may have values representing respective identifications of companies, at which the associated member has been employed. Other examples of profile attributes are the industry attribute and the region attribute. Respective values of the industry attribute and the region attribute in a member profile may indicate that the associated member is employed in the banking industry in San Francisco Bay Area.

An on-line social network system may maintain not only respective profiles of members, but also profiles of organizations, such as companies, universities, etc. For example, a profile of a company may be associated with a company web page and include information about the company. A company web page in the on-line social network system may include a visual control, e.g., a “Follow” button that a user may click to indicate that they would like to “follow” the company profile. A member profile representing a member that “follows” a company profile may include a link indicating this relationship between the member profile and the company profile. This relationship may be expressed in the context of the on-line social network system in that the news and notifications, e.g., regarding job openings at the company, changes in the organization of the company, new members on the executive team, etc., may be communicated to the member associated with the member profile, e.g., via the member's news feed web page, etc.

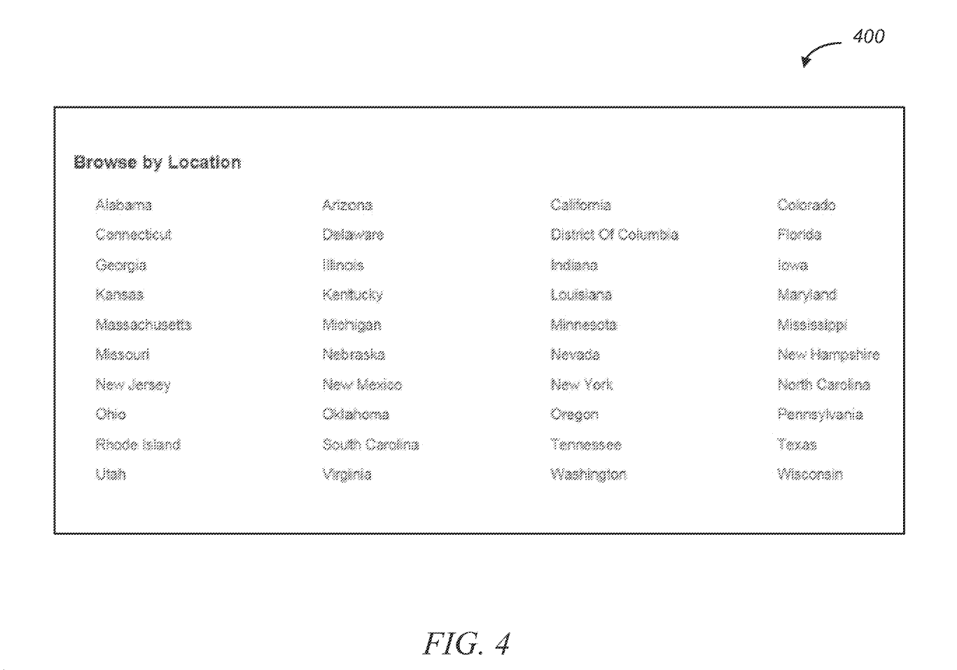

The on-line social network system also maintains information about job postings. A job posting, also referred to as merely “job” for the purposes of this description, is an electronically stored entity that includes information that an employer may post with respect to a job opening. The information in a job posting may include, e.g., industry, company, job position, required and/or desirable skills, geographic location of the job, etc. The on-line social network system may be configured to match member profiles with job postings, so that those job postings that have been identified as potentially being of interest to a member represented by a particular member profile are presented to the member on a display device for viewing using, e.g., a so-called job recommendation system. The job recommendation system identifies certain job postings as being of potential interest to a member and presents such job postings to the member in order of relevance with respect to the associated member profile. Members may access job postings by entering a search term into the search box and examining the returned search results. A search term may include one or more keywords or phrases representing repressive, job titles, professional skills, company names, geographic locations, etc. Another way to access job postings is to navigate to a web page representing a job search directory and click on (or otherwise engage) a link corresponding to a search term of interest (e.g., a company mane or a geographic location), which would cause presentation of references to the job postings containing that search term. An example representation of a user interface 400 for navigating a job search directory by location is shown in FIG. 4.

While the on-line social network system may be used beneficially to assist its members in their job searches, a person who may be considered an active job seeker may not necessarily be a member of the on-line social network system. At the same time, active job seekers, even if they are not yet members, may benefit when a search using an on-line search engine returns, as results, job postings maintained by the on-line social network system. The on-line social network system may be configured to provide to users, regardless of their membership with the on-line social network system, a rich job search experience where JSERPs (job search results pages) that originate from the on-line social network system are ranked at the top of the search results. The on-line social network system, in one embodiment, is configured to prioritize search terms (potential search terms) based on their respective predicted contribution to the ranking of JSERPs. The value of a job-related search term may be expressed as a priority score assigned to that search term. The term search term will be understood to mean a word or a phrase consisting of more than one word. The search terms that are being prioritized may represent, e.g., professions or a job titles, organizations, at which employment may be offered, such as, e.g., companies, law firms, universities, etc., as well as geographic locations. Some examples of search terms are “nurse,” “electrical engineer,” “product manager,” “Social Network Company,” “San Francisco Bay Area,” etc. It will be noted that, while an organization, at which employment may be offered, may be an entity other than a company, the term “company” will be used for the purposes of this description to refer to any organization, at which employment may be offered.

Given a great number of geographic locations associated with potential work places, it is beneficial to understand the value of JSERPs relative to one another—in other words, to determine the relative prioritization of a JSERPs listing jobs available at a certain location against JSERPs listing jobs available at other locations. It may be beneficial be able to determine the relative prioritization of different <location, keyword> pairs. For example, JSERPs (job search results pages) including the pair <Texas, oil> (listing jobs in the oil industry in Texas) may be of greater interest to users, as compared to JSERPs including the pair <Bangalore in India, oil> (listing jobs in the oil industry in Bangalore). As another example, San Francisco bay area locations may be ranked high for keywords pertaining to tech industry.

The prior solution for prioritization of JSERPs associated with locations was solely based on job counts. For instance, in our job directories, while listing top locations, we have been including locations that return the most number of jobs. The problem is that, just because a location has many job openings does not mean that the corresponding JSERP is valuable, or that a large fraction of our guests care about the location. This problem persists for prioritizing locations associated with different keywords as well.

One approach to prioritization of search terms is based on the number of job postings advertising jobs at a location. This approach, by itself, may not always be optimal, because it may lead to high ranking of staffing firms just because they have a lot of job openings. However, just because a particular geographic location has many job openings does not mean that the corresponding JSERPs are valuable, or that a large fraction of job seekers care about the location. In some scenarios, this problem may also need to be addressed in prioritizing locations associated with different keywords that are being used as search terms.

In one example embodiment, the on-line social network system includes or is in communication with a search engine optimization (SEO) system that is configured to calculate respective priority scores for certain search terms and use these priority scores for enhancing the users' on-line job search experience. A set of search terms to be scored may be selected automatically or manually and stored in a database as a bank of search terms. The SEO system may be configured to generate priority scores for different search terms, using a probabilistic model that takes into account a value expressing how likely the search term is to be included in a search query and a value expressing how likely it is that a search that includes the search term is to produce relevant results. A value expressing how likely the search term is to be included in a search query may be referred to as a popularity score. A value expressing how likely a search query that includes the search term is to produce relevant results may be referred to as a relevance score. The probabilistic model may be utilized beneficially for search terms that represent geographic locations, as well as for search terms that include the combination of a geographic location and a keyword.

A search term w that represents a location, at which employment may be offered, may be referred to as a location search term. In one embodiment, the SEO system may be configured to generate the importance value Imp(w) for a location search term w. The importance value for a location search term w may be generated by combining signals from data sources corresponding to the following dimensions: popularity, strength, and external signals. The SEO system may be configured to generate popularity value for a location search term utilizing information regarding how likely a location search term is to be issued in a search query by examining the search volume with respect to the searches within the on-line social network system, as well as by examining the search volume with respect to the searches within one or more third party search engines, as described in further detail later in the specification.

The strength signals used by the SEO system to generate the importance value for a location search term include one or more of: the number of current employees at the location represented by the location search term, the number of members of the on-line social network system at the location represented by the location search term (the number of member profiles in the on-line social network system that include the location identification in a field of the member profile for storing current employment information), the number of members who have ever worked at the location, the number of members who have worked at the location within a certain time period (e.g., within the last year or within the last 18 months). The number of members who have ever worked at the location may be determined as the number of member profiles in the on-line social network system that include the location identification in a field of the member profile for storing current employment information or in a field of the member profile for storing past employment information having the end date of past employment later than a predetermined date. Another strength signal used by the SEO system to generate the importance value for a location search term is the change (growth or decline) in the number of members at the location within a certain time period (e.g., within the last year or within the last 18 months). The external signals used by the SEO system to generate the importance value for a location search term include, e.g., population size for the location, as well as the change (growth or decline) in the population size at the location within a certain time period (e.g., within the last year or within the last 18 months). Information representing the strength signals and external signals may be obtained from a variety of sources, e.g., public and private databases, as well as data stored by the on-line social network system.

The SEO system may be configured to generate the importance value Imp(l,w) for a (location, keyword) pair. The importance value for a (location, keyword) pair may be generated by combining signals from data sources corresponding to the following dimensions: popularity, strength, and external sources. The SEO system may be configured to generate popularity value tier a (location, keyword) pair utilizing information regarding how likely the location search term is to be issued in a search query by examining the search volume with respect to the searches within the on-line social network system, as well as by examining the search volume with respect to the searches within one or more third party search engines, as described in further detail later in the specification.

The strength signals used by the SEO system to generate the importance value for a (location, keyword) pair include one or more of: the number of current members of the on-line social network residing or working at that location and who list the keyword within a skill or a job title in their member profile, the number of people who has ever been a member of the on-line social network system residing or working at that location and who list the keyword within a skill or a job title in their member profile, the number of members of the on-line social network system who have worked at that location within a certain time period (e.g., within the last year or within the last 18 months) and who list the keyword within a skill or a job title in their member profile, and the change (growth or decline) in the number of members of the on-line social network system who have worked at that location within a certain time period (e.g., within the last year or within the last 18 months) and who list the keyword within a skill or a job title in their member profile.

The external signals used by the SEO system to generate the importance value for a (location, keyword) pair may include population size for the location, as well as the change (growth or decline) in the population size at the location within a certain time period (e.g., within the last year or within the last 18 months).

Respective importance values generated for location search terms may be used to generate respective priority scores. In some embodiments, the priority score for a location search term is be generated by multiplying its relevance score by its importance score, e.g. using Equation 1 shown below.

PriorityScore(l)=Pr(RELEVANT & l)=Imp(l)*Pr(RELEVANT/l), Equation (1)

where w is a search term, Imp(l) is a value expressing importance of a keyword represented by the search term w, and Pr(RELEVANT/l) is probability expressing the relevance score for the search term l.

For a location, keyword) pair, (l,w), its priority score may be generated by multiplying its relevance score by its importance score, e.g. using Equation 2 shown below.

PriorityScore(l,w)=Pr(RELEVANT & l,w)=Imp(l,w)*Pr(RELEVANT/l,w), Equation (2)

where (l,w) is a (location, keyword) pair, Imp(l,w) is a value expressing importance of a (location, keyword) pair, and Pr(RELEVANT/l,w) is probability expressing the relevance score for the (location, keyword) pair.

Respective priority scores generated for location search terms are used to determine, which locations to highlight in the jobs directory (e.g., to determine which locations to include under each alphabet), to determine which JSERP landing pages (that list jobs at certain locations) to include in the jobs directory, as well as to determine which JSERP landing pages to be included into a sitemap submitted to one or more third party search engines (such as, e.g., Google® or Bing®).

When priority scores are generated for (location, keyword) pairs, their respective priority scores are used to determine, which (location, keyword) pairs to highlight in the jobs directory, which JSERP landing pages corresponding to the (location, keyword) pairs to include in the jobs directory, as well as to determine which JSERP landing pages to be included into a sitemap submitted to one or more third party search engines.

Returning to the discussion of a process for generating a popularity score for a search term and calculating probability of how likely the search term is to be included in a search query, in order to generate popularity score Pr(w) for a particular search term w (also referred to as a subject search term or merely a search term and that may be a location search term or any other search term), the SEO system monitors job-related searches that include the subject search term. In one embodiment, the SEO system monitors, for a period of time, all job-related searches performed by one or more certain target third party search engines (e.g., Google®, Yahoo!®), and, in some embodiments, also job-related searches performed within the on-line social network system. The results of monitoring of each of these sources with respect to the subject search term w are used to generate respective intermittent popularity values Pⱼ(w), where j is the j-th data source from k data sources. For example, Pⱼ(w) for Google® data source may be determined based on the percentage of job-related searches that include the search term w.

When the on-line social network system is used as a data source for determining Pⱼ(w), the SEO system considers every search request to be a job-related search. When a third party search engine is used as a data source for determining Pⱼ(w), the SEO system may first determine whether the intent of the search is related to job search and take into account only those searches that have been identified as job-related, while ignoring those searches that have not been identified as job-related. Identifying a job search directed to a third party search engine as being job-related could be accomplished by detecting the presence, in a search request, of additional terms that have been identified as intent indicators, such as, e.g., the word “job” or “career.”

Because the popularity values generated based on data obtained from different sources may be in different scales, the SEO system may be configured to first normalize the intermittent popularity values Pⱼ(w) for a given search term w, and then aggregate the normalized popularity values to arrive at the popularity score Pr(w). This approach may be expressed by Equation (3) shown below.

Pr(w)=popularityAggregateFunction(normFunction₁(P₁(w)), normFunction₂(P₂(w)), . . . , normFunctionₖ(Pₖ(w))) Equation (3)

In one embodiment, a different normalization function is used for each of the intermittent popularity value (normFunction1 for P₁(w), normFunction2 for P₂(w), etc.). The aggregation function, denoted as popularityAggregateFunction in Equation (2) above, can be chosen to be one of max, median, mean, mean of the set of normalized popularity values selected from a certain percentile range, e.g., from 20th to 80th percentile. In some embodiments, the aggregation function can be the output of a machine learning model (such as logistic regression) that is learned over ground truth data. The normalization function normFunctionⱼ(Pⱼ(w)) is to map each of the intermittent popularity value Pⱼ(w) to the same interval.

For example, the normalization function scale(Pⱼ(w)) may map each of the intermittent popularity value Pⱼ(w) to the interval [0, 1] and utilize three percentile values—the lower threshold (α-percentile value), the median (50-percentile value), and the upper threshold (β-percentile value). The normalization function performs piecewise linear mapping from the intermittent popularity values to [0, 1]. An intermittent popularity value is mapped to 0 if it is less than the lower threshold. Linear scaling to [0, 0.5] is performed for intermittent popularity values that are greater than or equal to the lower threshold and less than or equal to the median. Linear scaling to [0.5, 1] is performed for intermittent popularity values that are greater than or equal to the median and less than or equal to the upper threshold. An intermittent popularity value is mapped to 1 if it is greater than the upper threshold. The max value from the set of normalized popularity values may then be used as the aggregation function: max(scale(P₁(w)), scale(P₂(w)), . . . , scale(Pₖ(w))). The scaling applied to each of the intermittent popularity value may be different since the percentile values could be different for each intermittent popularity type.

In some embodiments, the SEO system may be configured to use the importance value of a location search term as the priority score for that search term. Yet in other embodiments, as stated above, respective importance values generated for the location search terms may be used to derive the respective corresponding priority scores, e.g., by multiplying the value expressing the importance value by the value expressing the relevance score generated for the location search term, as expressed by Equation (1) above.

As mentioned above, a value expressing how likely a search that includes the search term is to produce relevant results may be referred to as a relevance score. In one embodiment, the SEO system may be configured to determine the relevance score Pr(RELEVANT/w) for a search term w using multiple indicators of relevance.

One example of an indicator of relevance of a search term is the number of search results returned in response to a query that includes the search term and that originates from the on-line social network system. Another indicator of relevance of a search term may be related to respective quality scores assigned to the returned results. For example, a third party search engine returns search results in response to a query that includes a search term. The returned results each have a quality score assigned to it by the search engine. The sum of quality scores of those returned search results that originate from the on-line social network system may be used by the SEO system as one of the indicators of relevance of that search term. Yet another indicator of relevance of a search term may be obtained based on monitoring user engagement signals with respect to the search results returned in response to a query that includes the search term and that originate from the on-line social network system. For example, with respect to the search results returned in response to a query that includes a search term and that originate from the on-line social network system, the SEO system may monitor and record signals such as click through rate (CTR) for a certain number of top job results. These signals can be aggregated over individual job results (JSERPs) to obtain a combined user engagement score for that JSERP. For example, the SEO may utilize, as another indicator of relevance of a search term, the total CTR for the JSERP associated with the search term. Also, the SEO may utilize, as other indicators of relevance of a search term, an average dwell time (time spent viewing the job description/details before moving on to a different page or ending the session) for a certain number of top job results, as well as the total dwell time for the JSERP associated with the search term. This user engagement score may be then utilized in deriving the relevance score for the search term. Another indicator of relevance of a search term may be obtained by examining member profiles in the on-line social network system. For example, the SEO system may determine how frequently a search term in used in a member profile, e.g., to designate a current or past place of employment.

Different indicators of relevance with respect to a particular search term w are used to generate respective intermittent relevance values Pⱼ(RELEVANT/w), where j is the j-th data source from k data sources, Because the relevance values generated based on data obtained from different may be in different scales, the SEO system may be configured to first normalize the intermittent relevance values Pⱼ(RELEVANT/w) for a given search term w, and then aggregate the normalized relevance values to arrive at the relevance score Pr(RELEVANT/w). This approach may be expressed by Equation (4) shown below.

Pr(RELEVANT/w)=relevanceAggregateFunction(normFunction₁(P₁(RELEVANT/w)), normFunction₂(P₂(RELEVANT/w)), . . . , normFunction₁(P₁(RELEVANT/w))) Equation (4)

A different normalization function may be used for each of the intermittent relevance value (normFunction1 for P₁(RELEVANT/w), normFunction2 for P₂(RELEVANT/w), etc.). Furthermore, in some embodiments, these normalization functions are also different from those used for relevance score computation. The aggregation function, denoted as relevanceAggregateFunction in Equation (3) above, can be chosen to be one of max, median, mean, mean of the set of normalized relevance values selected from a certain percentile range, e.g., from 20th to 80th percentile. In some embodiments, the aggregation function can be the output of a machine learning model (such as logistic regression) that is learned over ground truth data. In some embodiments, the normalization function normFunctionⱼ(Pⱼ(RELEVANT/w)) is to map each of the intermittent relevance value Pⱼ(RELEVANT/w) to the same interval and utilize two threshold values—the lower threshold (ε1), and the upper threshold (ε2).

For example, with respect to the intermittent Pⱼ(RELEVANT/w) is the number of search results returned in response to a query that includes a search term that originate from the on-line social network system, the normalization function scale(Pⱼ(RELEVANT/w)) maps the job result count to [0, 1] using a step function: 0 if the job result count is fewer than the lower threshold, 1 if the job result count is greater than the upper threshold. If the job result count is greater than the lower threshold and less than the upper threshold, its normalized value is calculated as shown in Equation (5) below.

scale(Pⱼ(RELEVANT/w))=(Pⱼ(RELEVANT/w))−ε1)/(ε2−ε1) Equation (5)

In another example, where the intermittent Pⱼ(RELEVANT/w) is the sum of quality scores of those returned search results that originate from the on-line social network system, a combined quality score for the page and the search term w is derived using an aggregation function such as max, median, mean, mean of the values between certain percentiles (e.g., from 20th to 80th percentile), etc. The aggregation function can also take into account position discounting, that is, provide greater weight to jobs search results at top positions. As explained above, in some embodiments, respective relevance scores generated for job-related search terms may be used to derive respective priority scores, e.g., by multiplying the value expressing the relevance score for a search term by the value expressing the popularity score for that same search term, as expressed by Equation (1) above.

In determining the priority score for a (location, keyword) pair, (l,w), the SEO system uses, in addition to the importance value, the relevance score calculated for that (location, keyword) pair, as expressed by Equation (2) above. The SEO system determines the relevance score Pr(RELEVANT/l,w) for a a (location, keyword) pair (l,w), using multiple indicators of relevance. One example of an indicator of relevance of a (location, keyword) pair is the number of search results returned in response to a query that includes the keyword and the location as search terms and that originates from the on-line social network system. Another indicator of relevance of a (location, keyword) pair may be related to respective quality scores assigned to the returned results. For example, as explained above, a third party search engine returns search results in response to a query that includes the keyword and the location as search terms. The returned results each have a quality score assigned to it by the search engine. The sum of quality scores of those returned search results that originate from the on-line social network system may be used by the SEO system as one of the indicators of relevance of that (location, keyword) pair. Yet another indicator of relevance of a (location, keyword) pair may be obtained based on monitoring user engagement signals with respect to the search results returned in response to a query that includes the keyword and the location as search terms and that originate from the on-line social network system. The monitored and recorded engagement signals may be related to the click through rate (CTR) for a certain number of top job results. These signals can be aggregated over individual job results (JSERPs) to obtain a combined user engagement score for that JSERP. Other signals derived from monitoring user engagement with the search results may include the total CTR for the JSERP associated with the (location, keyword) pair, an average dwell time for a certain number of top job results, as well as the total dwell time for the JSERP associated with the (location, keyword) pair. Another indicator of relevance of a (location, keyword) pair may be obtained by examining member profiles in the on-line social network system. For example, the SEO system may determine how frequently a search term in used in a member profile, e.g., to designate a current or past location of the employer location.

As different indicators of relevance are used to generate respective intermittent relevance values Pⱼ(RELEVANT/l, w), with respect to a (location, keyword) pair (l,w), where j is the j-th data source from k data sources, these intermittent relevance values are normalized and then aggregated to arrive at the relevance score Pr(RELEVANT/l,w). The normalization and aggregation approach may be used as described above, with respect to normalizing and aggregating intermittent relevance values generated for a location search term.

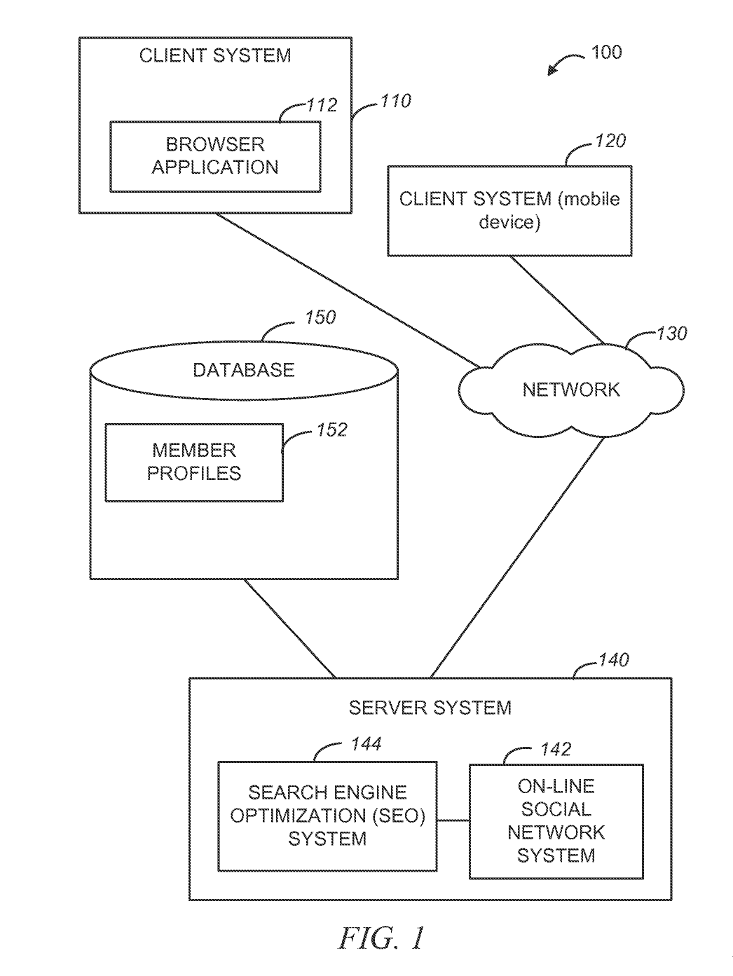

An example search term prioritization system may be implemented in the context of a network environment 100 illustrated in FIG. 1. As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line, social network is represented by a member profile that contains personal and professional information about the member and that may be associated with social links that indicate the member's connection to other member profiles in the on-line social network. Member profiles and related information may be stored in a database 150 as member profiles 152.

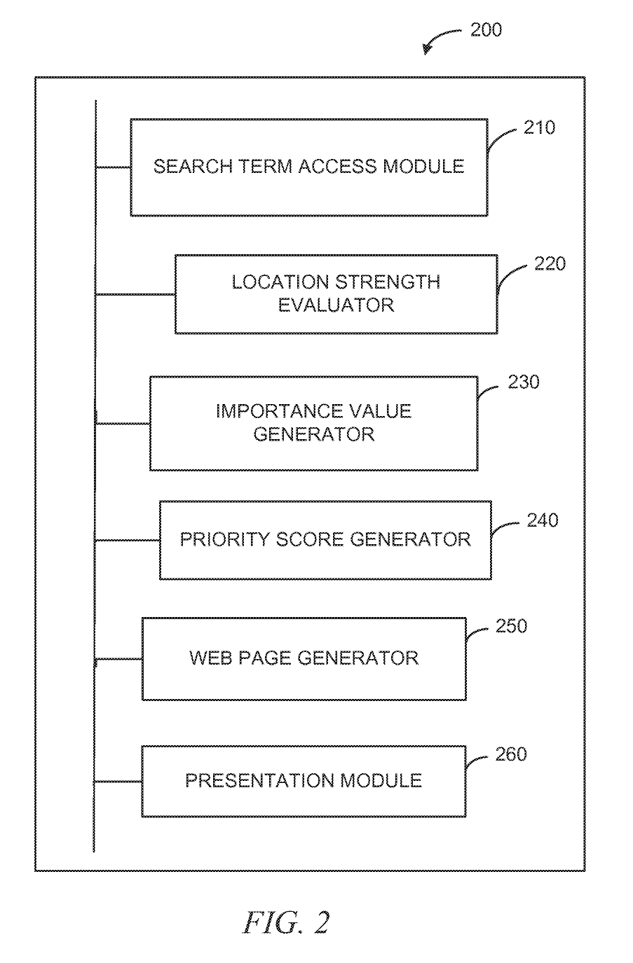

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a search engine optimization (SEO) system 144. As explained above, the SEO system 144 may be configured to prioritize search terms based on their respective predicted contribution to the ranking of JSERPs. The value of a job-related search term is expressed as a priority score assigned to that search term. In different embodiments the SEO system 144 generates priority scores for search terms, using a probabilistic model that takes into account a value expressing how likely the search term is to he included in a search query and/or a value expressing how likely is a search that includes the search term is to produce relevant results, as well as other signals, as described above. An example search term prioritization system, which corresponds to the SEO system 144 is illustrated in FIG. 2.

FIG. 2 is a block diagram of a system 200 to prioritize search terms in an on-line social network system 142 of FIG. 1. As shown in FIG. 2, the system 200 includes a search term access module 210, a location strength evaluator 220, an importance value generator 230, and a priority score generator 240. The search term access module 210 may be configured to access a search term that includes location identification representing a geographic location. In some embodiments, the search term comprises a further keyword in addition to a search term that includes location identification.

The location strength evaluator 220 may be configured to determine a number of members of the on-line social network system associated with the location identification. The number of members associated with the location identification may be determined as a number of member profiles in the on-line social network system 142 that include the location identification in a field of the member profile for storing current employment information, as a number of member profiles in the on-line social network system that include the location identification in a field of the member profile for storing current employment information or in a field of the member profile for storing past employment information, or as a value that reflects a change in the number of members at a geographic location represented by the location identification.

This information used by the importance value generator 230 to generate importance value for the search term. The importance value reflects how frequently job-related search requests include the search term. In one embodiment, the importance value generator 230 determines the importance value for the search term using both the importance value reflecting how frequently job-related search requests include the search term and also a value reflecting the number of members of the on-line social network system associated with the location identification. Where the search term comprises a further keyword in addition to the location identification, the importance value of the search term reflects importance of the associated (location, keyword) pair.

The job-related search requests taken into consideration in determining the importance value for a search term may be those requests directed to one or more search engines, such as a search engine provided by a third party and a search engine provided by the on-line social network system 142. To generate importance value for a search term, the importance value generator 230 uses other signals, as described above, such as population size of the geographic location identified by the location identification.

The priority score generator 240 may be configured to generate a priority score for the search term, utilizing the importance value. The priority score generator 240 may also use, in addition to the importance value, a relevance score generated for the search term. The relevance score expresses how likely a search request that includes the search term is to produce relevant results. For example, a priority score for a search term may be generated by calculating a product of the importance value and the relevance score. The priority score generator 240 may also be configured to adjust the priority score based on frequency of appearance of the subject search term in certain fields (e.g., past or current employment fields) of member profiles maintained by the on-line social network 142. Where the search term comprises a further keyword in addition to the location identification, the priority score generated for the search term by the priority score generator 240 is the priority value of the associated (location, keyword) pair.

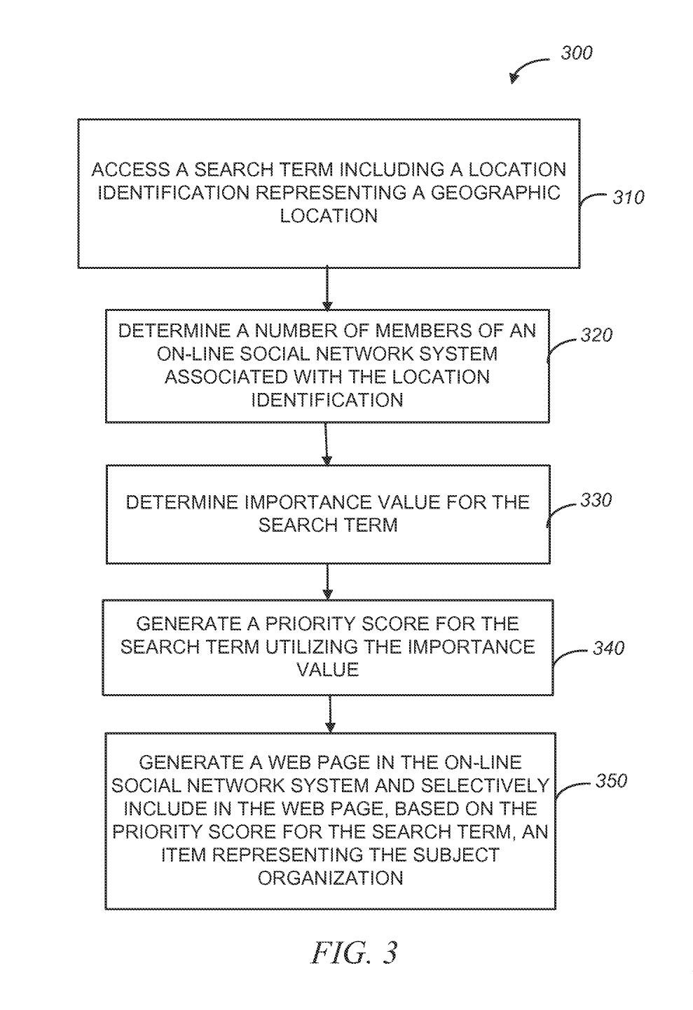

Also shown in FIG. 2 are a web page generator 250 and a presentation module 260. The web page generator 250 may be configured to generate a web page in the on-line social network system 142 and selectively include in the web page, based on the priority score for the search term, an item representing geographic location identified by the location identification. For example, the search terms that have higher priority scores may be included into a web page representing the job search directory, while the search terms that have lower priority scores may be omitted from that web page. As a further example, those job posting that include one or more search terms that have higher priority scores may be included into a sitemap submitted to one or more third party search engines, while those job posting that do not include any of the higher-scoring search terms may be omitted from such sitemap. The presentation module 260 may be configured to cause presentation, on a display device, various web pages (e.g., a web page representing a member profile or a web page representing a job search directory). Some operations performed by the system 200 may be described with reference to FIG. 3.

FIG. 3 is a flow chart of a method 300 to prioritize search terms in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 1.

As shown in FIG. 3, the method 300 commences at operation 310, when the search term access module 210 of FIG. 2 accesses a search term that includes location identification representing a geographic location. The location strength evaluator 220 of FIG. 2 determines, at operation 320, a number of members of an on-line social network system 142 associated with the location identification. At operation 330, the importance value generator 230 of FIG. 2 determines importance value for the search term. The importance value reflects how frequently job-related search requests include the search term and also reflects the number of members of the on-line social network system associated with the location identification.

At operation 340, the priority score generator 240 of FIG. 2 generates a priority score for the search term utilizing the importance value. As mentioned above, the priority score for a search term may be generated using, in addition to its importance value, also its relevance score. The relevance score for a search term may be generated using methodologies described above. At operation 350, the web page generator of FIG. 2 generates a web page in the on-line social network system 142 and selectively includes in the web page, based on the priority score generated by the priority score generator 240 for the search term, an item representing the geographic location. The presentation module 250 of FIG. 2 then causes presentation of the web page on a display device.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

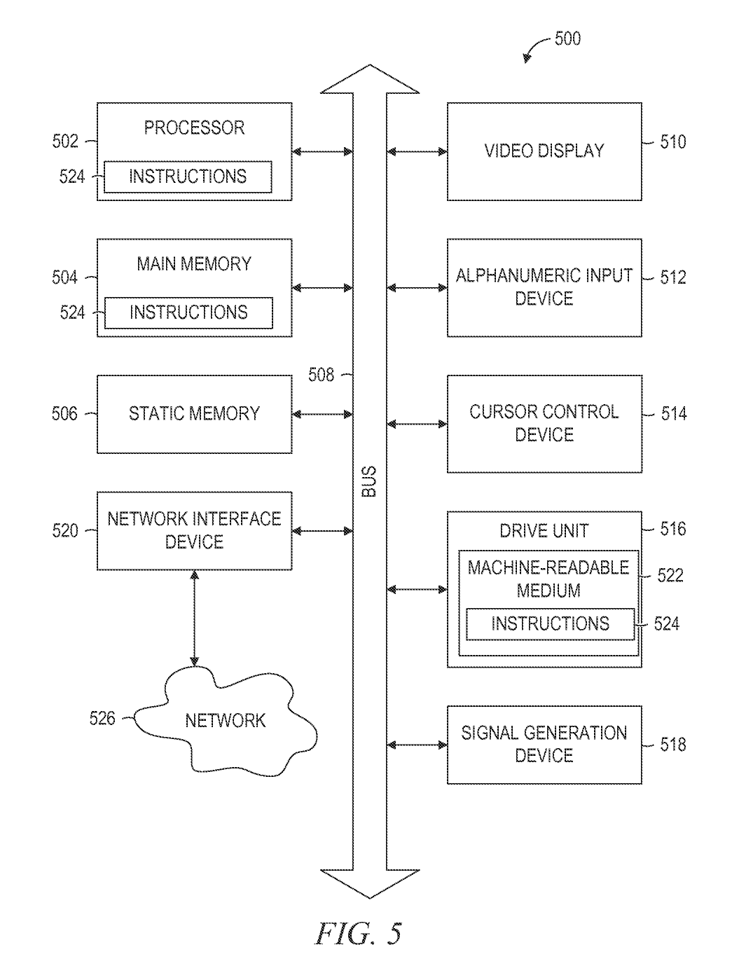

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (CPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not he configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to prioritize search terms representing locations in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a search term, the search term including a location identification representing a geographic location;
determining a number of members of an on-line social network system associated with the location identification;
determining importance value for the search term, the importance value reflecting how frequently job-related search requests include the search term and also reflecting the number of members of the on-line social network system associated with the location identification, using at least one processor;
generating a priority score for the search term, utilizing the importance value;
based on the priority score for the search term, selectively including, in a web page generated by the on-line social network system, an item representing the geographic location; and
causing presentation of the web page on a display device.

2. The method of claim 1, wherein the search term comprises a further keyword in addition to the location identification.

3. The method of claim 1, wherein the number of members of the on-line social network system associated with the location identification is a number of member profiles in the on-line social network system that include the location identification in a field of the member profile for storing current employment information.

4. The method of claim 1, wherein the number of members of the on-line social network system associated with the location identification is a number of member profiles in the on-line social network system that include the location identification in a field of the member profile for storing current employment information or in a field of the member profile for storing past employment information.

5. The method of claim 1, wherein the number of members of the on-line social network system associated with the location identification reflects a change in the number of members at a geographic location represented by the location identification.

6. The method of claim 1, wherein the generating of the importance score comprises utilizing one or more external signals.

7. The method of claim 6, wherein the external signals include population size for a geographic location represented by the location identification.

8. The method of claim 1, wherein the job-related search requests are directed to one or more search engines, the one or more search engines include a third party search engine and a search engine provided by an on-line social network system, the third party search engine and the on-line social network system provided by different entities.

9. The method of claim 1, wherein the generating of the priority score for the search term comprises using, in addition to the importance value, a relevance score generated for the search term, the relevance score expressing how likely a search request that includes the search term is to produce relevant results.

10. The method of claim 1, wherein the web page is a job search directory page or a web page that represents job postings maintained by the on-line social network system.

11. A computer-implemented system comprising:
a search term access module, implemented using at least one processor, to access a search term, the search term including a location identification representing a geographic location;
a location strength evaluator, implemented using at least one processor, to determine a number of members of an on-line social network system associated with the location identification;
an importance value generator, implemented using at least one processor, to determine importance value for the search term, the importance value reflecting how frequently job-related search requests include the search term and also reflecting the number of members of the on-line social network system associated with the location identification;
a priority score generator, implemented using at least one processor, to generate a priority score for the search term, utilizing the importance value;
a web page generator, implemented using at least one processor, to generate a web page in the on-line social network system and selectively include in the web page, based on the priority score for the search term, an item representing the geographic location; and
a presentation module, implemented using at least one processor, to cause presentation of the web page on a display device.

12. The system of claim 11, wherein the search term comprises a further keyword in addition to the location identification.

13. The system of claim 11, wherein the number of members of the on-line social network system associated with the location identification is a number of member profiles in the on-line social network system that include the location identification in a field of the member profile for storing current employment information.

14. The system of claim 11, wherein the number of members of the on-line social network system associated with the location identification is a number of member profiles in the on-line social network system that include the location identification in a field of the member profile for storing current employment information or in a field of the member profile for storing past employment information.

15. The system of claim 11, wherein the number of members of the on-line social network system associated with the location identification reflects a change in the number of members at a geographic location represented by the location identification.

16. The system of claim 11, wherein the generating of the importance score comprises utilizing one or more external signals.

17. The system of claim 16, wherein the external signals include population size for a geographic location represented by the location identification.

18. The system of claim 11, wherein the job-related search requests are directed to one or more search engines, the one or more search engines include a third party search engine and a search engine provided by an on-line social network system, the third party search engine and the on-line social network system provided by different entities.

19. The system of claim 11, wherein the priority score generator is to generate the priority score for the search term comprises using, in addition to the importance value, a relevance score generated for the search term, the relevance score expressing how likely a search request that includes the search term is to produce relevant results.

20. A machine-readable non-transitory storage medium having instruction data executable by a machine to cause the machine to perform operations comprising:
accessing a search term, the search term including a location identification representing a geographic location;
determining a number of members of an on-line social network system associated with the location identification;
determining importance value fir the search term, the importance value reflecting how frequently job-related search requests include the search term and also reflecting the number of members of the on-line social network system associated with the location identification;
generating a priority score for the search term, utilizing the importance value;
based on the priority score for the search term, selectively including, in a web page generated by the on-line social network system, an item representing the geographic location; and
causing presentation of the web page on a display device.
